(19) United States
(12) Patent Application Publication
(10) Pub. No.: US 2007/0157681 A1
(43) Pub. Date: Jul. 12, 2007

(54) Controlling assembly for a cable lock to control movement of a latch bolt to threadingly secure an object

(75) Inventor: Tony Miao, Taipei Hsien (TW)

Correspondence Address: Thomas E. Sisson;Jackson Walker, LLP, Suite 2100, 112 E. Pecan, San Antonio, TX, 78205, US

(73) Assignee: Jin Tay Industries Co., Ltd.

(21) Appl. No.: 11/329,749

(22) Filed: Jan. 11, 2006

(51) Int. Cl. E05B 73/00

(52) U.S. Cl. 70/58

(57) ABSTRACT

A controlling assembly for a locking device includes a latch bolt adapted to be engaged with the axle and rotatably extending out of the casing, the latch bolt having a threading formed on a free end of the latch bolt, a dial ring adapted to be movable and rotatable relative to the axle and a clutch device provided to selectively engage the dial ring and the latch bolt. When the latch bolt is engaged with the dial ring and the locking device is in an unlocked status to allow the axle to move axially inside the casing, rotation of the dial ring is able to drive the latch bolt to rotate simultaneously so that the latch bolt is able to threadingly engage with an object to be protected.

### BACKGROUND OF THE INVENTION

1. Field of the Invention

The present invention relates to a controlling assembly, and more particularly to a controlling assembly for a cable lock to control movement of a latch bolt to threadingly secure an object.

2. Description of the Prior Art

A cable lock normally is applied in exhibition site where numerous products are being displayed on shelves. During exhibition, it is quite difficult to monitor the customers' behavior to prevent the products from being stolen. Therefore, the cable lock having a cable extending out from the lock core is widely used to secure the safety of the products. One end of the cable is firmly connected to the lock core and the other end of the cable is first extended through a portion of the object to be secured and then a fixation which is firmly connected to a surface, such as a wall or a ground. Thereafter, the cable is connected to the lock core. Using the fixation to secure the safety of the product does accomplish the purpose of preventing the object from being stolen. However, because the cable extends through a portion of the object, the overall appearance of the object is blocked by the cable, which is bad in appealing the customers' interests. Also, the cable crossing a large portion of the object will get in the way when operating the object becomes necessary.

To overcome the shortcomings, the present invention tends to provide an improved controlling assembly of a cable lock to mitigate the aforementioned problems.

### SUMMARY OF THE INVENTION

The primary objective of the present invention is to provide a controlling assembly for a cable lock to control movement of a latch bolt which is rotatably extending out of the cable lock. A clutch device is provided to control engagement between a dial ring and the latch bolt having a threading formed on a free end of the latch bolt such that when the clutch device is activated, the rotation of the dial ring allows the latch bolt to connect/disconnect an object.

In another objective of the present invention, the clutch device of the present invention is composed of a toothed hole defined in the dial ring and ratchet teeth mounted on the latch bolt so that when the ratchet teeth is received in the toothed hole in the dial ring, rotation of the dial ring is able to drive the latch bolt to rotate simultaneously.

In yet another objective of the present invention, a locking device is provided to have an axle movably received in the locking device and engaged with an end of a sleeve which is extending from a side face of the dial ring such that when the locking device is in an unlocked status, the axle is movable relative to the locking device, the dial ring is slightly moved resulted from the movement of the axle to allow the ratchet teeth to be received in the toothed hole and when the locking device is in a locked status, the axle is immovable relative to the locking device, the ratchet teeth is not received in the toothed hole in the dial ring such that the rotation of the dial ring is not driving the latch bolt to rotate. Thus the object securely connected to the latch bolt is secured.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing that a cable lock is provided with a controlling assembly received therein;

FIG. 2 is an exploded perspective view of the cable lock in FIG. 1;

FIG. 3 is an exploded perspective view showing an embodiment of the locking device FIG. 4 is a schematic side plan view showing the operation of the locking device shown in FIG. 3;

FIG. 5 is a schematic cross sectional view showing that the stops are not received in the gaps of the axle;

FIG. 6 is a schematic cross sectional view showing that the stops are received in the gaps of the axle;

FIG. 7 is a schematic end view showing the relationship between the axle and the inner wheel;

FIG. 8 is a schematic cross sectional view showing the situation where the recoil spring is not compressed;

FIG. 9 is a schematic cross sectional view showing that the recoil spring is released and the axle is moved;

FIG. 10 is a schematic end view showing the relationship between the axle and the inner wheel;

FIG. 11 is a schematic cross sectional view showing that the clutch device is activated so that rotation of the dial ring is able to drive the latch bolt to rotate simultaneously;

FIG. 12 is an exploded perspective view showing that the controlling assembly of the present invention is associated with a different locking device;

FIG. 13 is a schematic cross sectional view showing that the dial ring is not activated due to the status of the locking device;

FIG. 14 is a schematic cross sectional view showing that the dial ring is moved in response to the unlocked status of the locking device so that the clutch device is activated;

FIG. 15 is a schematic view showing the relationship between the latch bolt and the dial ring before the clutch device is activated; and

FIG. 16 is a schematic view showing the relationship between the latch bolt and the dial ring after the clutch device is activated.

### DETAILED DESCRIPTION OF THE PREFERRED EMBODIMENT

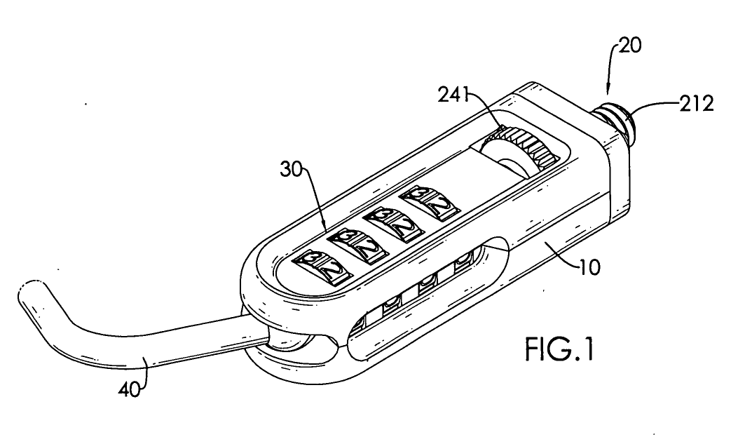

With reference to FIG. 1, it is noted that a cable lock in accordance with the present invention includes a casing (10), a controlling assembly (20) and a locking device (30).

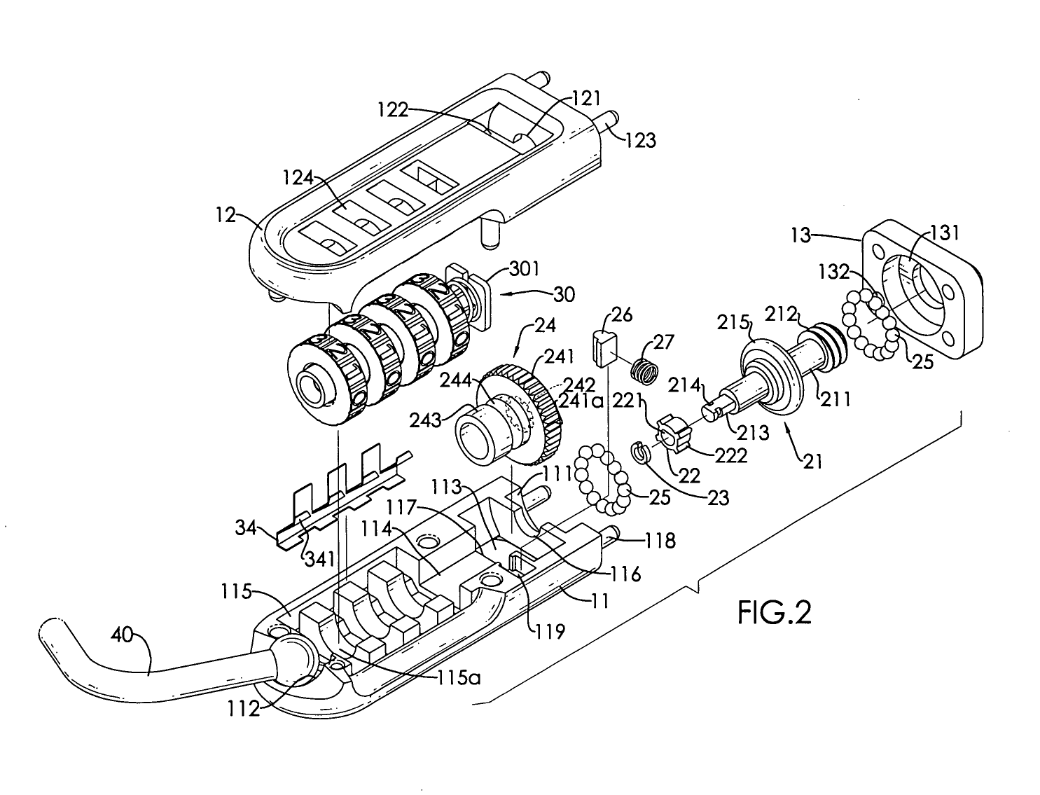

With reference to FIG. 2, the casing (10) of the present invention is composed of a bottom case (11) and a top case (12) securely connected to the bottom case (11) to define therebetween a receiving space to receive therein the locking device (30). The bottom case (11) is provided with a first arcuate space (111) defined in one end of the bottom case (11), a first compartment (113) separated from the first arcuate space (111) via a baffle (116), a mediate compartment (114) and a second compartment (115) in communication with the mediate compartment (114). The mediate compartment (114) has a depth shallower than that of the first compartment (113) so that a step (117) is formed between the first compartment (113) and the mediate compartment (114). A cutout (119) is defined in a side face defining the first compartment (113) to receive therein an abutting spring (27) an end of which is abutted against a side face of the cutout (119) and a block (26) a side of which is engaged with a free end of the abutting spring (27). Multiple seats (115a) are formed on a bottom face defining the second compartment (115). A second arcuate space (112) is defined in the bottom case (11) and opposite to the first arcuate space (111). A cable (40) is securely received in the second arcuate space (112). Multiple first rods (118) extend from a side face of the bottom case (11).

The top case (12) is provided with a receiving space (121) defined to correspond to the first arcuate space (111), a through hole (122) corresponding to and communicating with the first compartment (113) of the bottom casing (11) and multiple windows (124) each corresponding to one of the seats (115a). Multiple second rods (123) extend from a side face of the top case (11). A front cover (13) is provided to the casing (10) and has a central through hole (131) and multiple positioning holes (132) defined in a periphery of the front cover (13) to correspond to the first rods (118) and the second rods (123). Therefore, when the first rods (118) and the second rods (123) are respectively extended into and riveted in the positioning holes (132), the combination of the bottom casing (11), the top casing (12) and the front cover (13) is finished.

The controlling assembly (20) of the present invention is composed of a latch bolt (21), a positioning ring (22) having ratchet teeth (222) formed thereon, a clip (23) mounted on the latch bolt (21) to secure the position of the positioning ring (22), a dial ring (24) and two bearings (25) each provided on one side of the latch bolt (21) to be opposite to one another. The latch bolt (21) includes a bolt section (211) with a threading (212) formed on an outer periphery of the free end of the bolt section (211) and a rod section (213) having a non-circular cross section and a recess (214) defined in an outer periphery of a free end of the rod section (213) to correspond to the clip (23). A flange (215) is formed on the bolt section (211) and received between the first arcuate space (111) of the bottom casing (11) and the receiving space (121) of the top casing (12). The positioning ring (22) has a non-circular through hole (221) to correspond to the rod section (213) of the latch bolt (21) and multiple ratchet teeth (222) extending from the positioning ring (22). The clip (23) is received in the recess (214) of the latch bolt (21) after the non-circular rod section (213) is extended through the non-circular through hole (221) of the positioning ring (22) so that the position of the positioning ring (22) on the rod section (213) is secured by the clip (23). Preferably, the clip (23) is a C shaped clip. Each of the bearings (25) is provided on one side of the flange (215) to be opposite to one another so that after the flange (215) is received between the first arcuate space (111) of the bottom casing (11) and the receiving space (121) of the top casing (12), the bearings (25) help to smoothen rotation of the latch bolt (21) relative to the casing (10). The dial ring (24) is composed of a disk (241), a centrally defined passage (not numbered), a toothed hole (242) in communication with the passage to correspond to the ratchet teeth (222) of the positioning ring (22), a sleeve (243) integrally extending from a side of the disk (241) and an annular recess (244) defined in an outer periphery of the sleeve (243) to correspond to the block (26) which is received in the cutout (119) of the bottom casing (11). In addition, the disk (241) is provided with a rough face (241a) on a face of the disk (241) to help control of the disk (241).

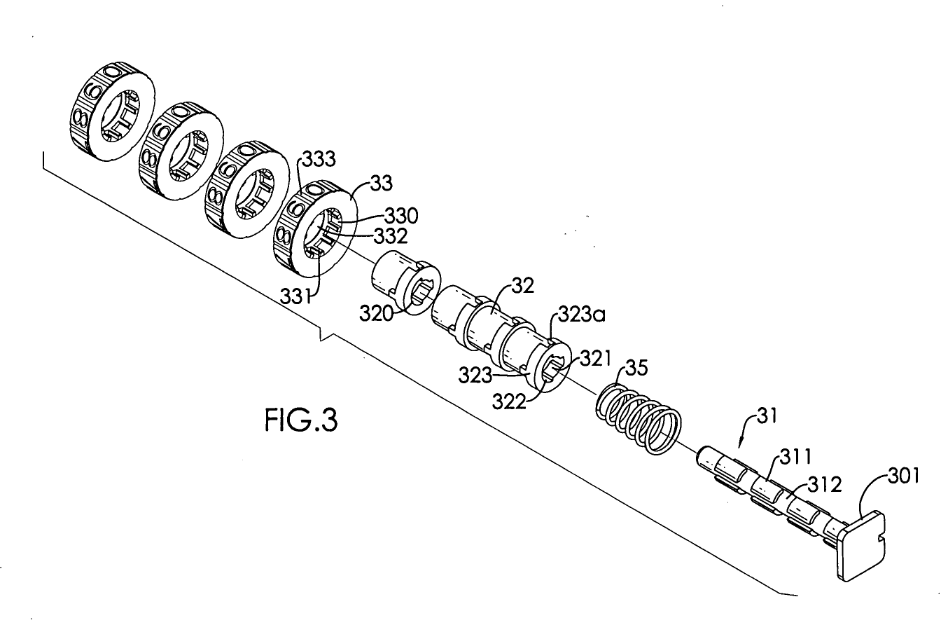

With reference to FIG. 3, the locking device (30) is composed of an axle (31), multiple inner wheels (32), multiple outer wheels (33) and a recoil spring (35).

The axle (31) has an abutting plate (301) formed on a proximal end thereof to engage with a free end of the sleeve (243) of the dial ring (24), multiple bosses (311) spaced apart from each other on an outer periphery of the axle (31) and multiple gaps (312) axially defined between two adjacent bosses (311). Each inner wheel (32) is provided with a through hole (320) defined through the inner wheel (32), multiple stops (321) formed on an inner face defining the through hole (320), multiple receiving gaps (322) defined in the inner periphery defining the through hole (320) and each receiving gap (322) being defined between two adjacent stops (321) and a crown (323) formed on an outer periphery of the inner wheel (32) and having a cutout (323a) defined in the crown (323). Each outer wheel (33) has a central hole (330) defined to receive therein a corresponding one of the inner wheels (32), ribs (331) formed on an inner periphery defining the central hole (330) to receive therein the cutout (323a) of the corresponding one of the inner wheels (32), an inner flange (332) formed on a peripheral edge defining the central hole (330) and grooves (333) defined in an outer periphery of the outer wheel (33).

With reference to FIG. 4, when the locking device (30) is assembled, a positioning spring (34) having a bent (341) is provided inside the bottom casing (11) and the bent (341) is able to be received in a corresponding one of the grooves (333) of the outer wheel (33).

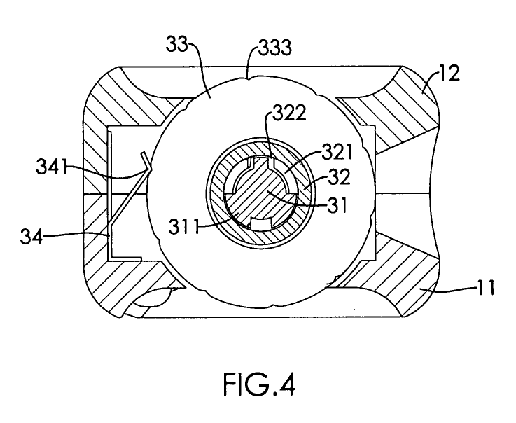

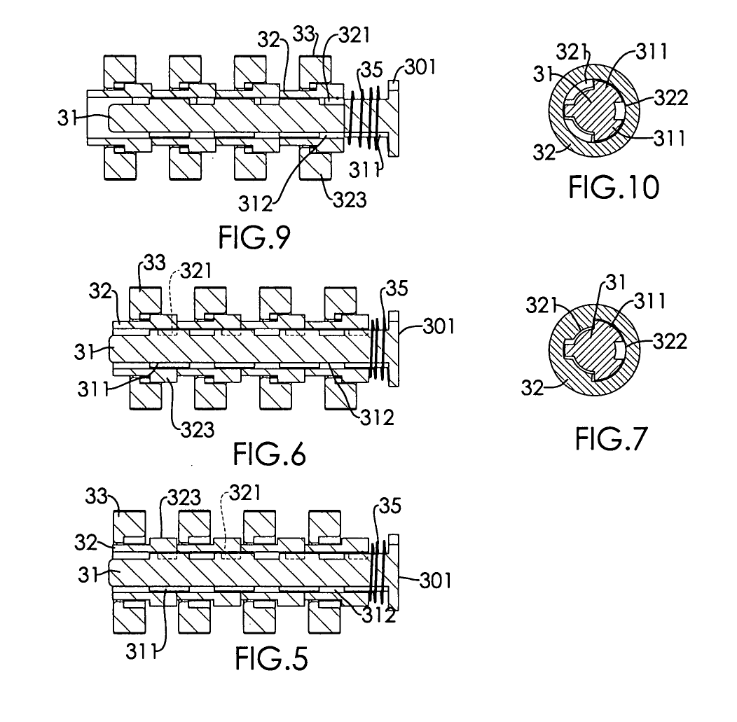

With reference to FIGS. 5-10, it is noted that a recoil spring (35) is mounted around the axle (31) and between the abutting plate (301) and the top most inner wheel (32) so that all the inner wheels (32) are forced by the recoil spring (35) to move in a direction opposite to a position where the abutting plate (301) is located. When the stops (321) are engaged with the bosses (311) of the axle (31), the inner wheels (32) as well as the outer wheels (33) are not rotatable relative to the axle (31). When the user is changing the combination sequence of the combination lock in an unlocked status, the user pushes the inner wheels (32) toward the abutting plate (301) to press the recoil spring (35). Then the user is able to rotate the outer wheels (33) to select the combination. After the combination is determined, the user release the inner wheels (32) to allow the inner wheels (32) to be secured to the outer wheels (33) via the rib (331) received in the corresponding cutout (323a).

When the combination lock is in an unlocked status, the axle (31) is movable relative to the inner wheels (32) as well as the outer wheels (33). That is, when the combination sequence is correct, all the stops (321) align with the gaps (312) and all the bosses (311) align with the receiving gaps (322). Thus the axle (31) is movable. On the contrary, when the combination lock is in a locked status, the stops (321) are mis-aligned with the gaps (312) and aligned with the bosses (311). Under such a situation, the axle (31) is immovable.

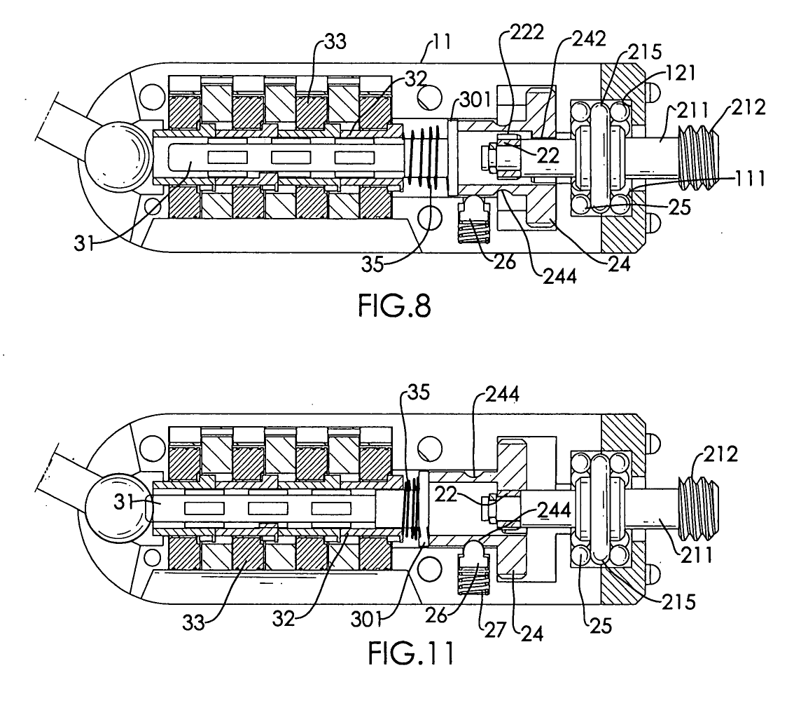

With reference to especially FIGS. 8 and 11, it is noted that after the combination of the controlling assembly (20) inside the casing (10) is finished and the flange (215) is rotatably received between the first annular space (111) of the bottom casing (11) and the receiving space (121) of the top casing (12), movement of the dial ring (24) to move the axle (31) away from the latch bolt (21) when the locking device (30) is in an unlocked status allows the ratchet teeth (222) to be received in the toothed hole (242) of the dial ring (24). Meanwhile, the block (26) abutted by the abutting spring (27) is received in the annular recess (244) of the dial ring (244) so as to position the dial ring (24). Thereafter, rotation of the dial ring (24) is able to drive the latch bolt (21) to rotate simultaneously. However, when the ratchet teeth (222) is not received in the corresponding toothed hole (242) of the dial ring (24), the rotation of the dial ring (24) will not drive the latch bolt (21) to rotate.

Therefore, it is to be noted that when the locking device (30) is in the unlocked status, the user is able to rotate the dial ring (24) to threadingly extend the latch bolt (21) into an object to be secured. On the contrary, when the locking device (30) is in the locked status, the rotation of the dial ring (24) will not be able to drive the latch bolt (21) to rotate due to the separation of the ratchet teeth (222) from the toothed hole (242). Thus unauthorized personnel having no knowledge of the correct combination of the locking device (30) is not able to steal the object which is securely connected to the latch bolt (21).

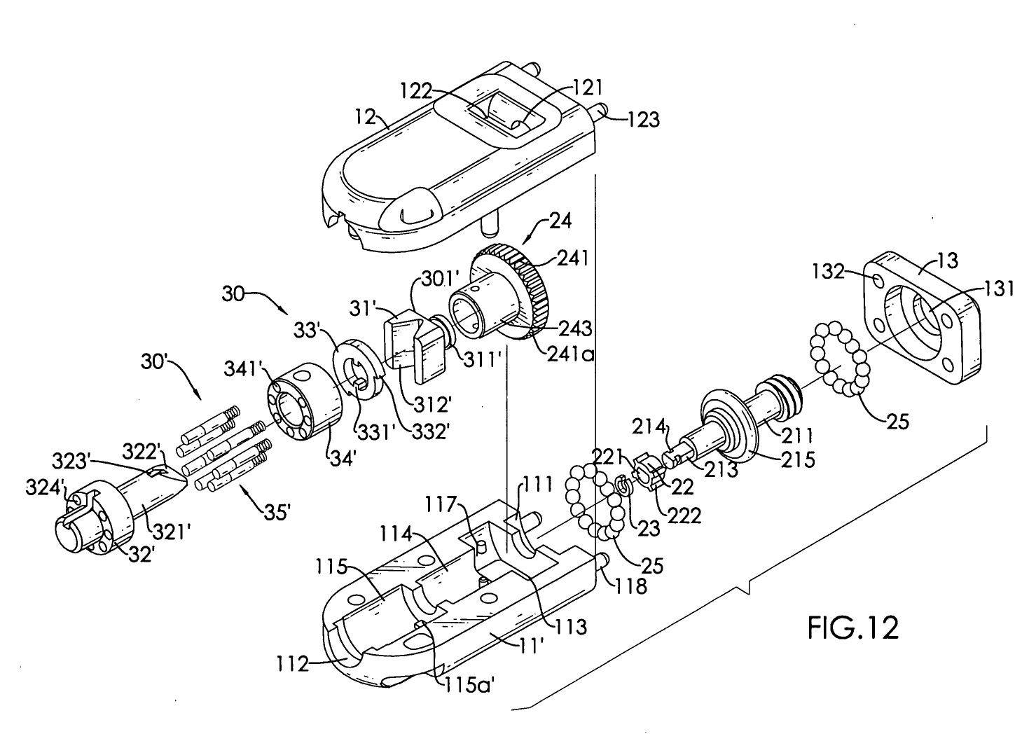

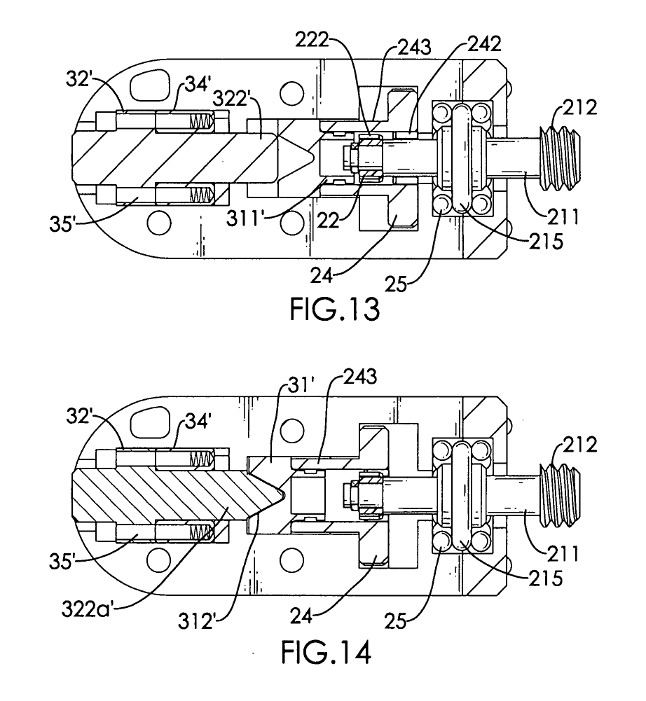

With reference to FIGS. 12, 13 and 14, a different application of the controlling assembly (20) of the present invention is shown, wherein the controlling assembly (20) is applied to a cylindrical lock (30′), i.e. the locking device. The locking device in this embodiment includes a pushing block (31′), a first pin seat (32′), a limiting plate (33′), a second pin seat (34′) and multiple pins (35′).

The pushing block (31′) is composed of a tube (311′) extending out from a side thereof and a V-shaped cutout (312′). The first pin seat (32′) is composed of a rod (321′) with a tapered end (322′) formed on a free end of the rod (321′), two positioning apertures (323′) oppositely defined in the rod (321′) and multiple first pin holes (324′). The limiting plate (33′) is composed of a centrally defined through hole, two bosses (331′) oppositely formed on an inner periphery defining the centrally defined through hole and two fingers (332′) oppositely formed on an outer periphery thereof to correspond to a stop (115a′) formed on an inner face of the second compartment (115). The second pin seat (34′) has multiple second pin holes (341′) defined through the second pin seat (34′). The multiple pins (35′) are extended into the first pin holes (324′) and the second pin holes (341′). Because how the cylindrical lock, the locking device is assembled is not the focus of this application, the combination thereof is omitted. However, after the combination of the locking device is finished, it is noted that the tube (311′) is received in the sleeve (243) of the dial ring (24) and when the locking device is in a locked status, the first pin seat (32′) is not able to rotate relative to the second pin seat (34′). That is, some of the pins (35′) are located in-between the first pin seat (32′) and the second pin seat (34′), which makes the first pin seat (32′) immovable relative to the first pin seat (34′). Under such a situation, it is noted that the tapered end (322′) of the first pin seat (32′) is abutted to a side face of the V-shaped cutout (312′) of the pushing block (31′) and there is no axial movement of the rod (321′) allowed. Therefore, it is impossible to move the dial ring (24) to allow the ratchet teeth (222) to be received in the toothed hole (242). However, when the locking device is in an unlocked status, the first pin seat (32′) is rotatable relative to the second pin seat (34′) such that the tapered end (322′) is able to be received in the V-shaped cutout (312′) by moving the dial ring (24) toward the second pin seat (34′). Movement of the dial ring (24) allows the ratchet teeth (222) to be received in the toothed hole (242) in the dial ring (24). Therefore, rotation of the dial ring (24) drives the latch bolt (21) to threadingly extend into an object to be protected.

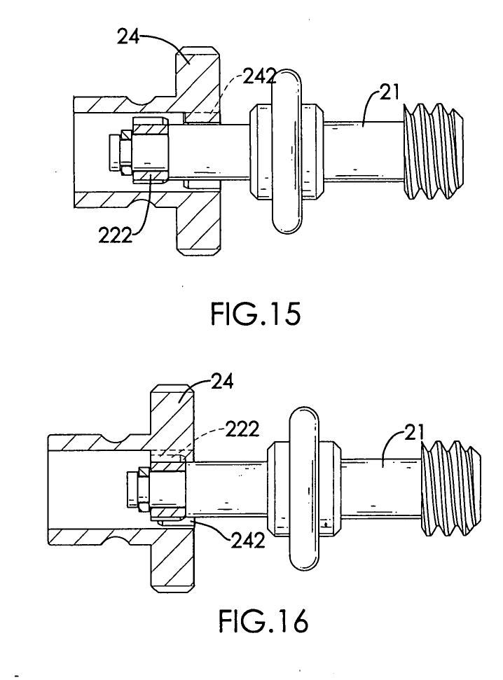

With reference to FIGS. 15 and 16, it is noted that when the axial movement of the dial ring (24) relative to the latch bolt (21) is allowed, the ratchet teeth (222) is able to be received inside the corresponding toothed hole (242) in the dial ring (24). Thus rotation of the dial ring (24) enables the latch bolt (21) to rotate simultaneously.

In conclusion, the clutching movement of the engagement/disengagement between the ratchet teeth (222) and the toothed hole (242) depending on the locking status of the locking device (30,30′), with which the user is able to secure the safety of his property.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A controlling assembly for a locking device having a casing and an axle selectively movable inside the casing to be in response to a locking status of the locking device, the controlling assembly comprising:
a latch bolt adapted to be engaged with the axle and rotatably extending out of the casing, the latch bolt having a threading formed on a free end of the latch bolt;
a dial ring adapted to be movable and rotatable relative to the axle; and
a clutch device provided to selectively engage the dial ring and the latch bolt such that when the latch bolt is engaged with the dial ring and the locking device is in an unlocked status to allow the axle to move axially inside the casing, rotation of the dial ring is able to drive the latch bolt to rotate simultaneously so that the latch bolt is able to threadingly engage with an object to be protected.

2. The controlling assembly as claimed in claim 1, wherein the latch bolt includes a bolt section having the threading formed at a free end of the bolt section, a rod section extending oppositely to the bolt section and a flange formed on the latch bolt to be sandwiched between the bolt section and the rod section.

3. The controlling assembly as claimed in claim 2 further comprising:
a positioning ring securely mounted on the rod section; and
two bearings each provided at one side of the flange of the latch bolt to smoothen rotation of the latch bolt

4. The controlling assembly as claimed in claim 1, wherein the latch bolt has sleeve extending from one side of the latch bolt and an annular recess defined in an outer periphery of the sleeve, a block is adapted to be received in the casing to be received in the annular recess when the dial ring is moved.

5. The controlling assembly as claimed in claim 2, wherein the latch bolt has a sleeve extending from one side of the latch bolt and an annular recess defined in an outer periphery of the sleeve, a block is adapted to be received in the casing to be received in the annular recess when the dial ring is moved.

6. The controlling assembly as claimed in claim 3, wherein the latch bolt has a sleeve extending from one side of the latch bolt and an annular recess defined in an outer periphery of the sleeve, a block is adapted to be received in the casing to be received in the annular recess when the dial ring is moved.

7. The controlling assembly as claimed in claim 3, wherein the clutch device is composed of a toothed hole defined in the dial ring and ratchet teeth formed on the positioning ring so that when the dial ring is moved in response to the unlocked status of the locking device, the ratchet teeth is received in the toothed hole in the dial ring and the rotation of the dial ring is able to drive the latch bolt to rotate simultaneously.

8. The controlling assembly as claimed in claim 4, wherein the clutch device is composed of a toothed hole defined in the dial ring and ratchet teeth formed on the positioning ring so that when the dial ring is moved in response to the unlocked status of the locking device, the ratchet teeth is received in the toothed hole in the dial ring and the rotation of the dial ring is able to drive the latch bolt to rotate simultaneously.

9. The controlling assembly as claimed in claim 5, wherein the clutch device is composed of a toothed hole defined in the dial ring and ratchet teeth formed on the positioning ring so that when the dial ring is moved in response to the unlocked status of the locking device, the ratchet teeth is received in the toothed hole in the dial ring and the rotation of the dial ring is able to drive the latch bolt to rotate simultaneously.

10. The controlling assembly as claimed in claim 6, wherein the clutch device is composed of a toothed hole defined in the dial ring and ratchet teeth formed on the positioning ring so that when the dial ring is moved in response to the unlocked status of the locking device, the ratchet teeth is received in the toothed hole in the dial ring and the rotation of the dial ring is able to drive the latch bolt to rotate simultaneously.

11. The controlling assembly as claimed in claim 10, wherein the rod section of the latch bolt is provided with a recess defined in an outer periphery thereof to receive therein a clip so that the positioning ring is positioned by the clip.

12. The controlling assembly as claimed in claim 4 further comprising an abutting spring adapted to be received in the casing to abut one end of the block so that the block is urged by the abutting spring to be selectively received in the annular recess to maintain position of the dial ring after being moved.

13. The controlling assembly as claimed in claim 5 further comprising an abutting spring adapted to be received in the casing to abut one end of the block so that the block is urged by the abutting spring to be selectively received in the annular recess to maintain position of the dial ring after being moved.

14. The controlling assembly as claimed in claim 6 further comprising an abutting spring adapted to be received in the casing to abut one end of the block so that the block is urged by the abutting spring to be selectively received in the annular recess to maintain position of the dial ring after being moved.

15. The controlling assembly as claimed in claim 7 further comprising an abutting spring adapted to be received in the casing to abut one end of the block so that the block is urged by the abutting spring to be selectively received in the annular recess to maintain position of the dial ring after being moved.

16. The controlling assembly as claimed in claim 8 further comprising an abutting spring adapted to be received in the casing to abut one end of the block so that the block is urged by the abutting spring to be selectively received in the annular recess to maintain position of the dial ring after being moved.

17. The controlling assembly as claimed in claim 9 further comprising an abutting spring adapted to be received in the casing to abut one end of the block so that the block is urged by the abutting spring to be selectively received in the annular recess to maintain position of the dial ring after being moved.

18. The controlling assembly as claimed in claim 10 further comprising an abutting spring adapted to be received in the casing to abut one end of the block so that the block is urged by the abutting spring to be selectively received in the annular recess to maintain position of the dial ring after being moved.

19. The controlling assembly as claimed in claim 11 further comprising an abutting spring adapted to be received in the casing to abut one end of the block so that the block is urged by the abutting spring to be selectively received in the annular recess to maintain position of the dial ring after being moved.
